(19) United States
(12) Patent Application Publication
(10) Pub. No.: US 2023/0328721 A1
(43) Pub. Date: Oct. 12, 2023

(54) TERMINAL

(71) Applicant: NTT DOCOMO, INC., Tokyo (JP)

(72) Inventor: Tomoya Ohara, Chiyoda-ku, Tokyo (JP)

(73) Assignee: NTT DOCOMO, INC., Tokyo (JP)

(21) Appl. No.: 17/755,419

(22) PCT Filed: Nov. 7, 2019
(86) PCT No.: PCT/JP2019/043777

§ 371 Date: May 3, 2023

(51) Int. Cl. H04W 72/1268; H04B 1/713; H04W 74/08; H04W 72/23

(52) U.S. Cl. CPC H04W 72/1268; H04B 1/713; H04W 74/0833; H04W 72/23

(57) ABSTRACT

Disclosed is a terminal including: a control unit acquiring a gap length between a first hop and a second hop in PUSCH transmission to which frequency hopping in a random access procedure is applied; and a transmitting unit performing the PUSCH transmission by the first hop and then the PUSCH transmission by the second hop after the gap length.

### TECHNICAL FIELD

The present invention relates to a terminal in a radio communication system.

### BACKGROUND ART

In a 3rd Generation Partnership Project (3GPP), in order to further increase system capacity, further increase a data transmission rate, and further decrease latency in a radio section, a radio communication scheme to be referred to as 5G or new radio (NR) (hereinafter, the radio communication scheme will be referred to as “NR”) has been considered. In 5G, in order to satisfy a required condition of setting the latency in the radio section to be less than or equal to 1 ms while attaining a throughput of greater than or equal to 10 Gbps, various radio technologies and network architectures have been considered (for example, Non-Patent Document 1).

### CITATION LIST

### Non-Patent Document

Non-Patent Document 1: 3GPP TS 38.300 V15.6.0 (2019-06)
Non-Patent Document 2: 3GPP TS 38.321 V15.6.0 (2019-06)

### SUMMARY OF THE INVENTION

### Problem to be Solved by the Invention

The same random access procedure as that of LTE is designated even in NR (Non-Patent Document 2). Further, in NR, in order to decrease the latency and to reduce the power consumption, a random access procedure to be executed in two steps (referred to as 2-step RACH) has been considered.

In the 2-step RACH, in a first step, it is assumed that a user terminal transmits MsgA by a preamble resource and a PUSCH resource. In addition, it has been considered to apply frequency hopping to data transmission (PUSCH transmission) of MsgA.

However, a specific technology for performing suitable frequency hopping with respect to the PUSCH transmission of MsgA has not been proposed.

The invention has been made in consideration of the circumstances described above, and an object thereof is to provide a technology for enabling frequency hopping of PUSCH transmission in a random access procedure to be suitably executed.

### Means for Solving Problem

According to the disclosed technology, a terminal including: a control unit acquiring a gap length between a first hop and a second hop in PUSCH transmission to which frequency hopping in a random access procedure is applied; and

a transmitting unit performing the PUSCH transmission by the first hop and then the PUSCH transmission by the second hop after the gap length is provided.

### Effect of the Invention

According to the disclosed technology, a technology for enabling frequency hopping of PUSCH transmission in a random access procedure to be suitably executed is provided.

### BRIEF DESCRIPTION OF DRAWINGS

FIG. 1 is a diagram for illustrating a radio communication system in an embodiment of the invention;

FIG. 2 is a diagram for illustrating the radio communication system in the embodiment of the invention;

FIG. 3 is a diagram illustrating 4-step RACH;

FIG. 4 is a diagram illustrating 2-step RACH;

FIG. 5 is a diagram illustrating a basic operation example;

FIG. 6 is a diagram for illustrating an example of a determination method of MsgA PO;

FIG. 7 is a diagram illustrating an example of frequency hopping of MsgA PO;

FIG. 8 is a diagram illustrating an example in which MsgA PO and a common PUSCH resource are arranged;

FIG. 9 is a diagram illustrating an example in which MsgA PO and the common PUSCH resource are arranged;

FIG. 10 is a diagram for illustrating Example 1-1;

FIG. 11 is a diagram for illustrating Example 1-2;

FIG. 12 is a diagram for illustrating Example 1-2;

FIG. 13 is a diagram for illustrating Example 1-3;

FIG. 14 is a diagram for illustrating Example 1-4;

FIG. 15 is a diagram for illustrating Example 1-5;

FIG. 16 is a diagram for illustrating Example 2;

FIG. 17 is a diagram for illustrating Example 3;

FIG. 18 is a diagram for illustrating Example 4;

FIG. 19 is a diagram illustrating an example of a function configuration of a base station apparatus 10 in the embodiment of the invention;

FIG. 20 is a diagram illustrating an example of a function configuration of the user terminal 20 in the embodiment of the invention; and

FIG. 21 is a diagram illustrating an example of a hardware configuration of the base station apparatus 10 or the user terminal 20 in the embodiment of the invention.

### MODE(S) FOR CARRYING OUT THE INVENTION

Hereinafter, an embodiment of the invention will be described with reference to the drawings. Note that, the embodiment described below is an example, and an embodiment to which the invention is applied is not limited to the following embodiment. For example, the invention can also be applied to a random access procedure other than 2-step RACH.

The existing technology is suitably used in the operation of a radio communication system of an embodiment of the invention. The existing technology, for example, is the existing NR or LTE, but is not limited to the existing NR or LTE.

In addition, herein, the terms of the existing NR or LTE used in the specification, such as PUSCH, PDCCH, RRC, MAC, and DCI, are used, but a part represented by a channel name, a protocol name, a signal name, a function name, or the like used herein may be referred to as another name. In addition, in the following description, a “time domain” and a “frequency domain” may be replaced with a “time domain” and a “frequency domain”, respectively.

(System Configuration)

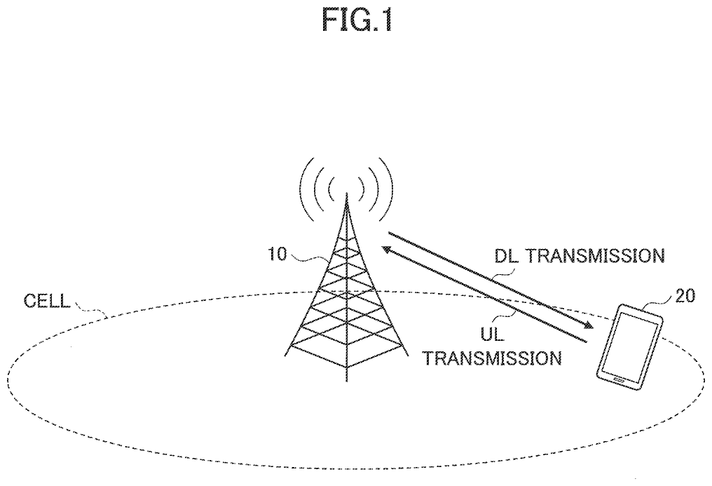

FIG. 1 is a diagram for illustrating the radio communication system in the embodiment of the invention. As illustrated in FIG. 1, the radio communication system in the embodiment of the invention includes a base station apparatus 10 and a user terminal 20. In FIG. 1, one base station apparatus 10 and one user terminal 20 are illustrated, but this is an example, and a plurality of base station apparatuses 10 and a plurality of user terminals 20 may be provided.

The base station apparatus 10 is a communication unit that provides one or more cells and performs radio communication with respect to the user terminal 20. A physical resource of a radio signal is defined by a time domain and a frequency domain, the time domain may be defined by the number of OFDM symbols, and the frequency domain may be defined by the number of subcarriers or the number of resource blocks. In addition, a transmission time interval (TTI) in the time domain may be a slot, or TTI may be a subframe.

The base station apparatus 10 transmits a synchronization signal, system information, and the like to the user terminal 20. The synchronization signal, for example, is NR-PSS and NR-SSS. The system information, for example, is transmitted by NR-PBCH or PDSCH, and is also referred to as broadcast information. As illustrated in FIG. 1, the base station apparatus 10 transmits a control signal or data to the user terminal 20 by a downlink (DL), and receives a control signal or data from the user terminal 20 by an uplink (UL). Note that, here, one of the control signal and the data to be transmitted by a control channel such as PUCCH and PDCCH is referred to as the control signal, and one of the control signal and the data to be transmitted by a shared channel such as PUSCH and PDSCH is referred to as the data, but such a referring method is an example.

The user terminal 20 is a communication unit having a radio communication function of a smart phone, a mobile phone, a tablet, a wearable terminal, a communication module for machine-to-machine (M2M), and the like. As illustrated in FIG. 1, in the user terminal 20, the control signal or the data is received from the base station apparatus 10 by DL, and the control signal or the data is transmitted to the base station apparatus 10 by UL, and thus, various communication services to be provided by the radio communication system are used. Note that, the user terminal 20 may be referred to as UE, and the base station apparatus 10 may be referred to as gNB. In addition, the user terminal 20 may be referred to as a “terminal”.

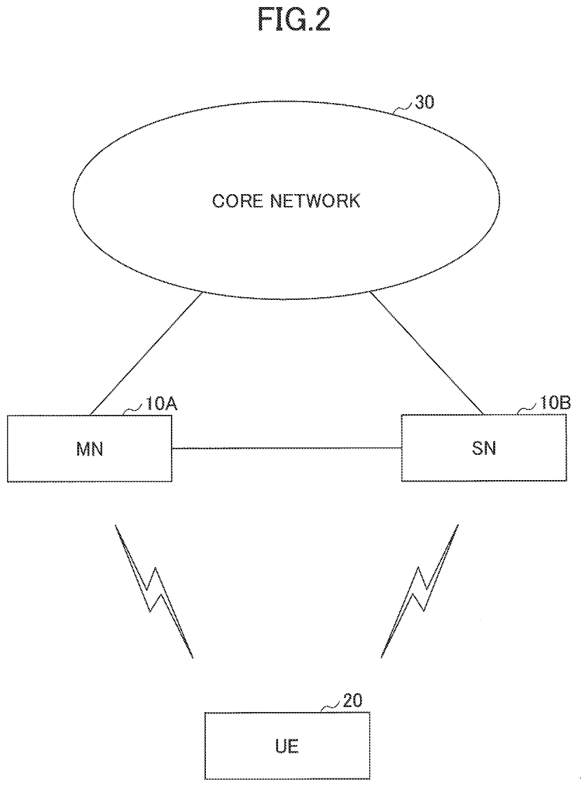

FIG. 2 illustrates a configuration example of the radio communication system in a case where dual connectivity (DC) is executed. As illustrated in FIG. 2, a base station apparatus 10A that is a master node (MN), and a base station apparatus 10B that is a secondary node (SN) are provided. Each of the base station apparatus 10A and the base station apparatus 10B is connected to a core network. The user terminal 20 is capable of performing communication with respect to both of the base station apparatus 10A and the base station apparatus 10B.

A cell group to be provided by the base station apparatus 10A that is MN is referred to as a master cell group (MCG), and a cell group to be provided by the base station apparatus 10B that is SN is referred to as a secondary cell group (SCG).

A processing operation in this embodiment may be executed by a system configuration illustrated in FIG. 1, may be executed by a system configuration illustrated in FIG. 2, or may be executed by other system configurations.

(Random Access Procedure)

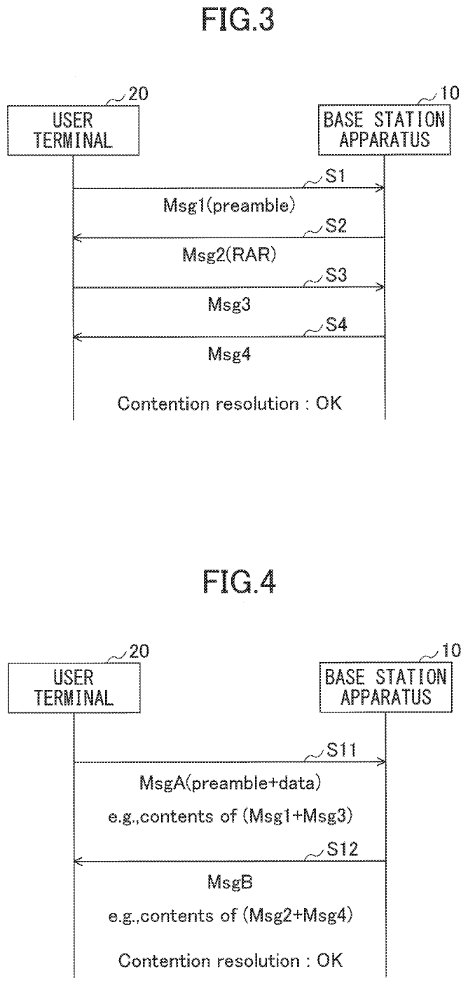

First, an example of a 4-step random access procedure that can be executed in the radio communication system in this embodiment will be described with reference to FIG. 3. Note that, FIG. 3 illustrates a contention based random access (CBRA) as an example. Note that, Examples 1 to 4 described below may be applied to PUSCH transmission in the 4-step random access procedure.

In NR, it is possible to execute the random access procedure by selecting an SS/PBCH block (also referred to as SSB, and may be referred to as a synchronization signal block or a synchronization signal), and to execute the random access procedure by selecting a channel state information-reference signal (CSI-RS).

The base station apparatus 10, for example, transmits SSB (or CSI-RS) for each beam, and the user terminal 20 monitors SSB (or CSI-RS) of each of the beams. The user terminal 20 selects SSB (or CSI-RS) of which reception power is greater than a predetermined threshold value, in a plurality of SSBs (or CSI-RSs), and transmits a Message1 (Msg1 (=RA Preamble)) by using a PRACH resource (an RACH occasion) corresponding to the selected SSB (or CSI-RS) (S1 of FIG. 3). Hereinafter, for convenience, the RA preamble will be referred to as a preamble. In addition, the RACH occasion may be referred to as a PRACH occasion.

In a case where the preamble is detected, the base station apparatus 10 transmits a Message2 (Msg2 (=RAR)) that is a response thereof to the user terminal 20 (S2). The user terminal 20 receiving Msg2 transmits a Message3 (Msg3) including predetermined information to the base station apparatus 10 (S3).

The base station apparatus 10 receiving Msg3 transmits a Message4 (Msg4) to the user terminal 20 (S4). In a case where it is ascertained that the predetermined information described above is included in Msg4, the user terminal 20 recognizes that Msg4 is self-addressed Msg4 corresponding to Msg3 described above (Contention Resolution: OK).

The random access procedure described above is the 4-step random access procedure, and thus, is referred to as 4-step RACH.

Next, in order to decrease the latency and to reduce the power consumption, the random access procedure (the 2-step RACH) of which the number of steps is reduced will be described with reference to FIG. 4. FIG. 4 illustrates the contention based random access (CBRA) as an example, and the 2-step RACH can also be applied to contention free random access (CFRA). The technology in this embodiment may be applied to any of CBRA and CFRA.

In S11, the user terminal 20 transmits a MessageA (MsgA) including a preamble and data to the base station apparatus 10. As an example, the user terminal 20 selects the PRACH resource as with the selection of the PRACH resource (the RACH occasion) in the 4-step RACH, transmits the preamble by the PRACH resource, and transmits the data by a PUSCH resource (referred to as a PUSCH occasion) associated with the PRACH resource. Note that, here, the preamble and the data, for example, correspond to Msg1 and Msg3 in the 4-step RACH.

In S12, the base station apparatus 10 transmits a MessageB (MsgB) to the user terminal 20. The contents of MsgB, for example, correspond to Msg2 and Msg4 in the 4-step RACH.

The random access procedure described above is a 2-step random access procedure, and thus, is referred to as 2-step RACH. The 2-step RACH is an example of a random access procedure of which the number of steps is reduced.

It is assumed that a preamble and PUSCH in the 2-step RACH are not integrated at least from the viewpoint of a physical layer. For example, it is assumed that transmission messages in a preamble resource and a PUSCH resource that are separate physical resources are collectively referred to as MsgA.

That is, it is assumed that one MsgA PUSCH occasion is one MsgA PUSCH resource, and one MsgA RACH occasion is one MsgA preamble resource. Note that, “one resource” indicates a resource that is used in one transmission. Hereinafter, the MsgA PUSCH occasion and the MsgA RACH occasion will be respectively referred to as the PUSCH occasion (abbreviated as PO) and the RACH occasion (abbreviated as RO).

In this embodiment, the RACH occasion is configured with respect to the user terminal 20 by an RRC message (RACH config). On the other hand, for example, a correspondence relationship between the PUSCH occasion and the RACH occasion is set, and the user terminal 20 determines the PUSCH occasion by the correspondence relationship.

The correspondence relationship between the PUSCH occasion and the RACH occasion may be any one of one-to-one, many-to-one, one-to-many, and many-to-many.

In consideration of the latency and the like, it is desirable that the RACH occasion and the PUSCH occasion are arranged in a position closest to the time domain, but the position is not limited to the position close to the time domain.

In this embodiment, the resource of the PUSCH occasion is designated by a relative position from the corresponding RACH occasion, as a resource designation method of the PUSCH occasion. However, this is an example, and the resource of the PUSCH occasion may be designated as an absolute position.

Resource designation information of the PUSCH occasion (time offset indicating the relative position described above, and the like) may be notified to the user terminal 20 from the base station apparatus 10 as a MsgA PUSCH configuration.

(Operation Example Relevant to Resource Designation of PUSCH Occasion)

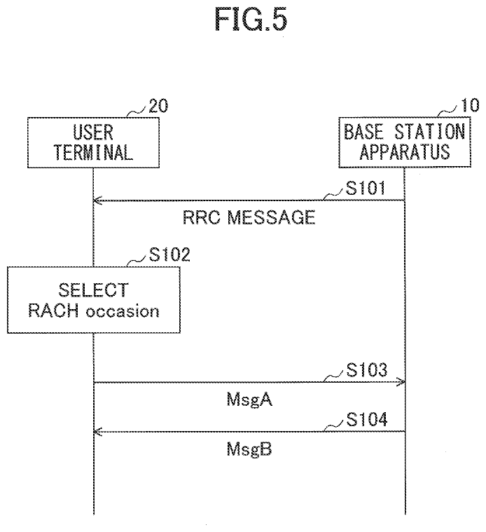

An operation example of the resource designation of the PUSCH occasion will be described with reference to FIG. 5.

In S101, the base station apparatus 10 transmits the RRC message for configuring one or more RACH occasions (may be referred to as an RACH resource) to the user terminal 20. In the RRC message, a relative position of the PUSCH occasion (may be referred to as the PUSCH resource) with respect to the RACH occasion may be configured, or an absolute position of the PUSCH occasion may be configured. The RRC message also include broadcast information (may be referred to as system information) such as a system information block (SIB). The configuration information relevant to the PUSCH occasion (the relative position described above, and the like) may be referred to as the MsgA PUSCH configuration.

The relative position of the PUSCH occasion with respect to the RACH occasion may be configured in the user terminal 20 from the base station apparatus 10 by the MsgA PUSCH configuration, or may be designated by specification or the like such that the configuration with respect to the user terminal 20 from the base station apparatus 10 is not performed. The fact that the relative position is set by the specification or the like indicates that the user terminal 20 retains in advance (pre-configures) the information of the relative position in a storage unit such as a memory.

In S102, the user terminal 20, for example, selects one SSB of which the reception power is greater than the threshold value in the plurality of SSBs, determines the RACH occasion corresponding to the selected SSB. The determined RACH occasion is one of one or more RACH occasions configured in S101.

In S103, the user terminal 20 transmits the preamble by using the RACH occasion specified in S102, and transmits the data (for example, Msg3) to the base station apparatus 10 by using the PUSCH occasion that is specified by the relative position (time offset or the like) from the RACH occasion. In S104, the user terminal 20 receives MsgB from the base station apparatus 10.

Here, an example of a designation method of the position of a time domain resource of the PUSCH occasion will be described. That is, an example of how the user terminal 20 determines the position of the time domain resource of the PUSCH occasion will be described.

The user terminal 20 determines the position of a time domain of the PUSCH occasion used in the transmission of MsgA, on the basis of a relative position from the position (a starting position or an ending position) of a time domain of the RACH occasion corresponding to the PUSCH occasion.

For example, the user terminal 20 specifies an RACH occasion #1 as the RACH occasion corresponding to the selected SSB. The user terminal 20 recognizes a time domain resource of the RACH occasion #1 by the configuration of the base station apparatus 10.

For example, in a case where a starting position of the RACH occasion #1 is set to a symbol #0 of a slot #1, and a relative position (a starting position) of a PUSCH occasion #1 used along with the RACH occasion #1 in order to transmit MsgA is set to “after two slots from the starting position of the RACH occasion #1”, the user terminal 20 determines that a resource starting from a symbol #0 of a slot #3 is a resource of the PUSCH occasion #1 used along with the RACH occasion #1 in order to transmit MsgA.

As described above, a time length representing the relative position described above (may be referred to as the time offset) may be a value that is pre-configured in the user terminal 20 (that is, a value that is designated by the specification or the like), or may be a value that is configured with respect to the user terminal 20 from the base station apparatus 10. Such a configuration may be performed by the RRC message, may be performed by MAC CE, or may be performed by DCI.

Each of a time length, a frequency position, and a frequency length (a bandwidth) of the PUSCH occasion may be the value that is pre-configured in the user terminal 20 (that is, the value that is designated by the specification or the like), or may be the value that is configured with respect to the user terminal 20 from the base station apparatus 10. In addition, the frequency position of the PUSCH occasion may be designated by a relative position of a frequency position of the RACH occasion (frequency offset), as with a time position.

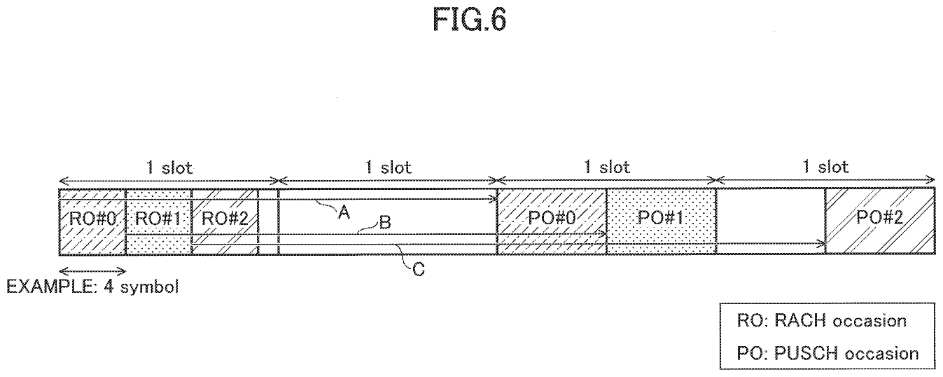

An operation example of the user terminal 20 relevant to the determination of the PUSCH occasion (PO) will be described with reference to FIG. 6. In FIG. 6, the position of the time domain of PO corresponding to RO is designated as a time length from the starting position of RO to the starting position of PO.

For example, in a case where the user terminal 20 selects RO #2 from RO #0 to RO #2, on the basis of the reception power of SSB, the user terminal 20 determines a resource including a starting position after the time length from a starting position of RO #2, as a resource of PO #2. Note that, a slot in which there is PO is referred to as a MsgA PUSCH slot.

In the example of FIG. 6, in each of PO #0 to PO #2 corresponding to RO #0 to RO #2, time lengths representing relative positions are designated or configured as A, B, and C, respectively. However, this is an example. A time length representing a common relative position may be designated or configured in PO #0 to PO #2.

In addition, in the example of FIG. 6, PO #0 to PO #2 corresponding to RO #0 to RO #2 are arranged such that they do not overlap each other in a time direction, but this is an example. For example, PO #0 and PO #1 may have the same time length and the same time position, and may be arranged such that frequency positions do not overlap each other. That is, PO #0 and PO #1 may be multiplexed by frequency division multiplexing (FDM). In this case, there may be no frequency gap between PO #0 and PO #1 (that is, PO #0 and PO #1 may be consecutive), or there may be a frequency gap between PO #0 and PO #1.

(Frequency Hopping)

Frequency hopping can be applied to the PUSCH transmission in MsgA. More specifically, intra-slot frequency hopping can be configured as an “intra-slot frequency hopping per PO for msgA is configurable using a per msgA configuration”, for each MsgA PO.

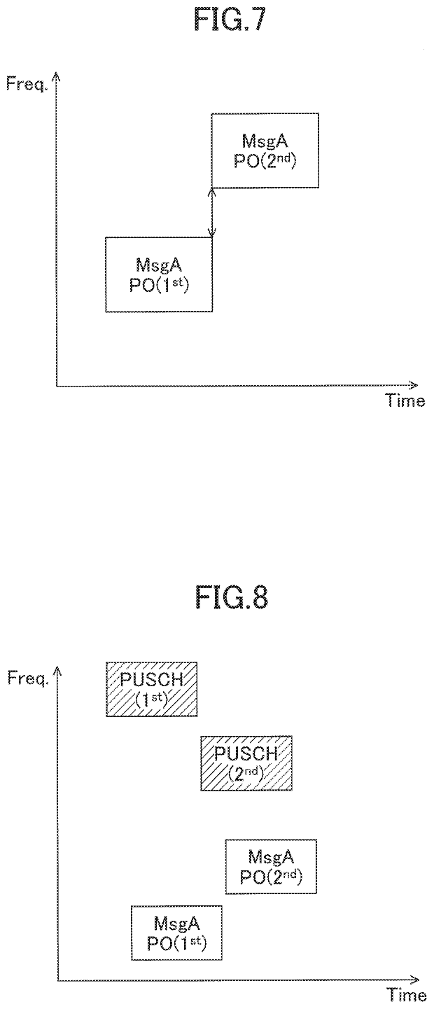

FIG. 7 illustrates the arrangement of the PUSCH resource (MsgA PO) used in a case where the user terminal 20 performs the PUSCH transmission of MsgA to which the frequency hopping is applied.

In the example of FIG. 7, frequency positions of two PUSCH resources obtained by dividing the length of the PUSCH resource in the time direction before the frequency hopping is applied (for example, PO #0 illustrated in FIG. 6) in half are shifted, and thus, the frequency hopping is attained.

Herein, one of two divided PUSCH resources (in the earlier time position) is referred to as a first hop (1sthop), and the other is referred to as a second hop (2ndhop).

A frequency difference (frequency offset) between the first hop and the second hop, for example, is configured by the configuration information (the MsgA PUSCH configuration) that is transmitted to the user terminal 20 from the base station apparatus 10. In addition, the frequency offset may be a value that is designated in advance. The frequency offset may be configured or designated for each PO (in the example of FIG. 6, PO #0 to PO #2), or may be commonly configured or designated in a plurality of POs.

In the example of FIG. 7, the user terminal 20 performs the PUSCH transmission by the first hop, and performs the PUSCH transmission by the second hop without a time gap. That is, there is no time gap between the first hop and the second hop.

Uplink transmission other than the PUSCH transmission of MsgA (PUSCH, PUCCH, and the like, having no relationship with the 2-step RACH) is not basically performed at an early timing in accordance with the value of timing advance (TA).

On the other hand, it is assumed that MsgA is transmitted from the user terminal 20 in a state where there is no information of propagation latency, and thus, it is considered that the PUSCH transmission of MsgA, for example, is performed as TA=0. Note that, even in the case of TA=0, a transmission timing of only the value of the designated TA offset may be set earlier.

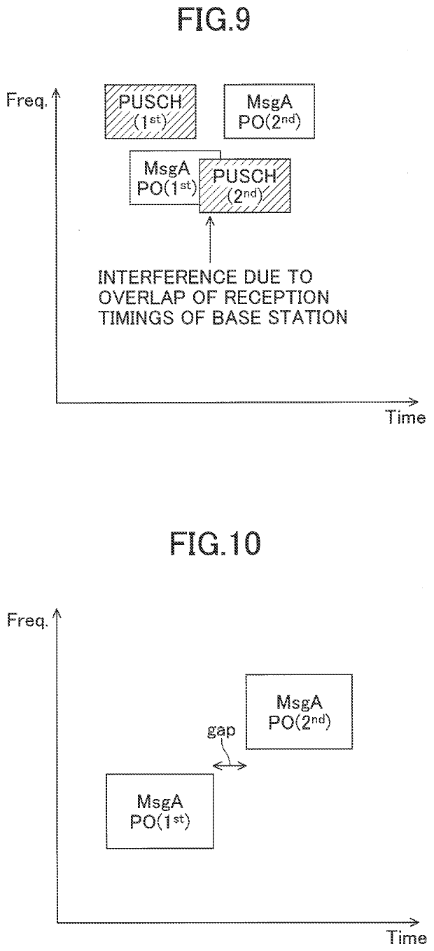

For this reason, the transmission timing is shifted between the PUSCH transmission of MsgA and the other uplink transmission. As illustrated in FIG. 8, even in a case where the transmission timing is shifted between the PUSCH transmission of MsgA and the other uplink transmission, and the frequency positions thereof are different from each other, interference does not occur, but as illustrated in FIG. 9, in a case where the frequency positions overlap each other, the interference occurs. In particular, in a case where the frequency hopping is applied, a possibility that interference between the user terminals, and the like occurs increases.

Note that, the occurrence of the interference due to TA is an example of the occurrence of the interference between the user terminals in a case where the frequency hopping is applied. A frequency range in which there is the PUSCH resource of MsgA is widened by applying the frequency hopping, and thus, there is a possibility that interference other than the interference due to TA also occurs.

Hereinafter, a technology that is capable of reducing the possibility of the interference between the user terminals that occurs due to the frequency hopping having no time gap between the first hop and the second hop and of suitably executing the frequency hopping of the PUSCH transmission in the 2-step RACH will be described by using Examples 1 to 4. Examples 1 to 4 described below can be implemented by being arbitrarily combined, unless there is a contradiction.

### Example 1

In Example 1, in a case where the frequency hopping is applied to the PUSCH transmission of MsgA, the time gap is provided between the first hop and the second hop. Note that, hereinafter, a “gap” indicates the time gap. The gap is provided between the first hop and the second hop, and thus, it is possible to shift the time position of the first hop or the second hop, and to prevent interference with respect to the other PUSCH transmission or the like, compared to a case where the gap is not provided. Hereinafter, Example 1-1 to Example 1-5 will be described as a more detailed example.

### Example 1-1

FIG. 10 illustrates the arrangement of a resource of MsgA PO in a case where the user terminal 20 performs the PUSCH transmission of MsgA by applying the frequency hopping, in Example 1-1. As illustrated in FIG. 10, there is the gap between the first hop and the second hop. Note that, “MsgA PO” may be referred to as PO.

In order to perform the PUSCH transmission of MsgA to which the frequency hopping of FIG. 10 is applied, for example, the starting position of PO (for example, the time offset from the corresponding RO), the time length, the frequency position, the frequency offset of the frequency hopping, and the time offset indicating the gap are configured in the user terminal 20 by the configuration information that is transmitted by the RRC message in S101 of FIG. 5. Note that, one or a plurality of a starting position of MsgA PO (for example, the time offset from the corresponding RO), the time length, the frequency position, the frequency offset of the frequency hopping, and the time offset indicating the gap may be designated by the specification or the like and may be configured in advance in the user terminal 20, without being configured from the base station apparatus 10.

When the user terminal 20 performs the PUSCH transmission of MsgA by a certain PO, on the basis of the configuration information described above, and the like, as illustrated in FIG. 10, the user terminal 20 performs the PUSCH transmission by the first hop with the application of the frequency hopping, and performs the PUSCH transmission by the second hop with a gap. Here, each of the first hop and the second hop has a time length half the time length of a common (in a case where the frequency hopping is not applied) PO.

The time offset indicating the gap is a time length between an ending time position of the first hop and a starting time position of the second hop. However, the time offset indicating the gap is not limited thereto. For example, the time offset indicating the gap may be a time length between a starting time position of the first hop and the starting time position of the second hop. The user terminal 20 acquires (calculates) a gap length between the first hop and the second hop used in the actual transmission, on the basis of the time offset described above, and uses the gap length as spacing between the first hop and the second hop in the transmission.

In addition, in the gap application of the user terminal 20, the starting time position of the first hop may be set to the starting time position of PO in a case where the frequency hopping is not applied, and the second hop may be shifted backward by the gap, or an ending time position of the second hop may be set to the ending time position of PO in a case where the frequency hopping is not applied, and the first hop may be shifted forward by the gap. An instruction of which setting is to be applied may be transmitted to the user terminal 20 from the base station apparatus 10.

### Example 1-2

Next, Example 1-2 will be described. Example 1-2 is different from Example 1-1 in a designation method of the gap. Otherwise Example 1-2 is identical to Example 1-1.

In Example 1-2, the time position of the second hop is indicated (or designated) on the basis of an ending time position of the MsgA PUSCH slot (an example of a reference time position) or a starting time position of the subsequent MsgA PO (an example of the reference time position), and thus, the gap between the first hop and the second hop is formed.

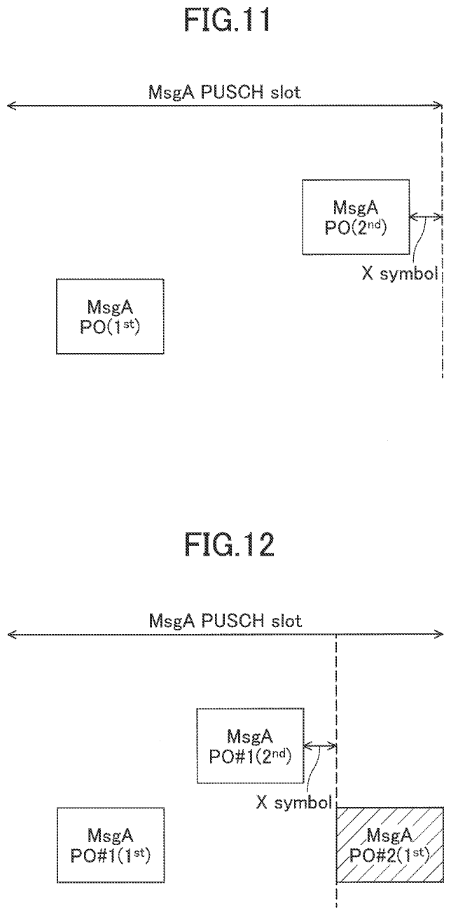

FIG. 11 illustrates an example of a case where a time length (the number of symbols) between the ending time position of the MsgA PUSCH slot and the ending time position of the second hop is configured or designated instead of the “time offset indicating the gap” of Example 1-1. In this case, the value of X is set on the basis of the starting time position of MsgA PO and the time length of MsgA PO such that a suitable gap can be obtained. The user terminal 20 acquires (calculates) the gap length between the first hop and the second hop used in the actual transmission, on the basis of the starting time position of MsgA PO, the time length of MsgA PO, the value of X, and the like, and uses the gap length in the transmission.

In the example of FIG. 11, the value of X may be 0. That is, the ending time position of the MsgA PUSCH slot and the ending time position of the second hop may be the same.

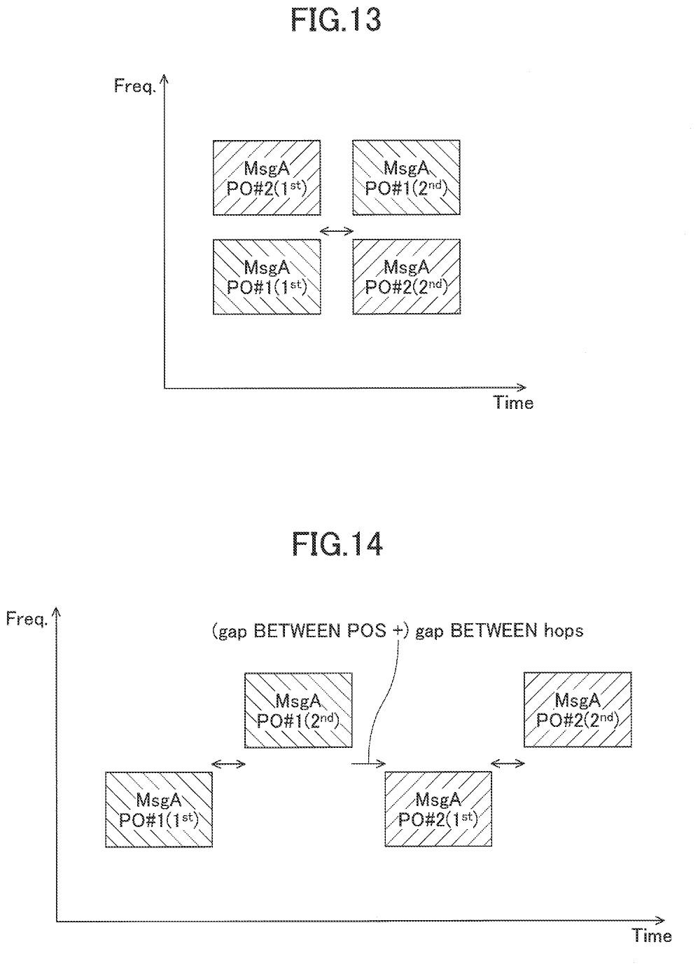

FIG. 12 illustrates an example of a case where a time length (the number of symbols) between the starting time position of the subsequent MsgA PO (in an example of FIG. 13, PO #2) and the ending time position of the second hop is configured or designated instead of the “time offset indicating the gap” of Example 1-1. In this case, the value of X is set on the basis of the starting time position of MsgA PO #1 and the time length of MsgA PO #1 such that a suitable gap can be obtained.

In the example of FIG. 12, the value of X may be 0. That is, the starting time position of the subsequent MsgA PO (in the example of FIG. 12, PO #2) and the ending time position of the second hop may be the same. Note that, in the subsequent PO, for example, in the case of PO #0 illustrated in FIG. 6, the subsequent PO thereof is PO #1.

### Example 1-3

Next, Example 1-3 will be described. For example, in a case where the first hop of PO #1 and the second hop of PO #1 are arranged by applying the frequency hopping to MsgA PO #1, as illustrated in FIG. 10 and the like, a space can be formed between a temporally backward position of the first hop and a temporally forward position of the second hop. In a case where the UL transmission having no relationship with the 2-step RACH is performed in such a space, there is a possibility that the interference with MsgA PO #1 occurs.

Therefore, in Example 1-3, as illustrated in FIG. 13, MsgA PO #2 that is MsgA PO different from MsgA PO #1 is arranged. By performing such arrangement, it is possible to prevent the other UL transmission from being performed in a resource in which such arrangement is performed.

More specifically, for example, as with the arrangement of the first hop and the second hop of PO #1 illustrated in FIG. 13, the starting position of MsgA PO #1 (for example, the time offset from the corresponding RO), the time length, the frequency position, the frequency offset of the frequency hopping, and the time offset indicating the gap are configured in the user terminal 20 from the base station apparatus 10, as the configuration information of PO #1. As described above, any one or a plurality thereof may be designated in advance.

In addition, as with the arrangement of the first hop and the second hop of PO #2 illustrated in FIG. 13, the starting position of MsgA PO #2 (for example, the time offset from the corresponding RO), the time length, the frequency position, the frequency offset of the frequency hopping, and the time offset indicating the gap are configured in the user terminal 20 from the base station apparatus 10, as the configuration information of PO #2. As described above, any one or a plurality thereof may be designated in advance.

The user terminal 20, for example, performs the PUSCH transmission of MsgA by using the first hop and the second hop of PO #1 illustrated in FIG. 13, in accordance with the configuration information described above, and the like, at the time of transmitting MsgA by PO #1.

A set of configuration information items of two MsgA POs as exemplified in FIG. 13, that is, the configuration information of PO #1 and the configuration information of PO #2 may be included in one configuration information item (the MsgA PUSCH configuration), or may be separated. That is, in the separated case, the configuration information of PO #1 may be config1, and the configuration information of PO #2 may be config2.

In addition, two MsgA POs may be MsgA PO subjected to FDM described above. For example, in the example illustrated in FIG. 6, in a case where PO #0 and PO #1 are multiplexed by FDM, and the frequency hopping is applied, for example, the arrangement as illustrated in FIG. 13 is obtained (FIG. 13 corresponds to a case where PO #1 and PO #2 are multiplexed by FDM).

For example, in a case where in PO #0 and PO #1 before the frequency hopping is applied, the frequencies are consecutively arranged by FDM, and the frequency hopping is applied, PO #0 and PO #1 are arranged in accordance with the frequency position to be hopped, without being consecutively arranged by the frequency.

In addition, in a case where in PO #0 and PO #1 before the frequency hopping is applied, the frequencies are consecutively arranged by FDM, and the frequency hopping is applied, the frequencies of PO #0 and PO #1 may be consecutively arranged. That is, the frequency offset of the hopping may be configured (or designated) such that the frequencies are consecutive. In a case where the consecutive arrangement is applied, in the example of FIG. 13, the first hop of PO #2 and the first hop of PO #1 are consecutive in a frequency direction, the second hop of PO #1 and the second hop of PO #2 are consecutive in the frequency direction.

### Example 1-4

Next, Example 1-4 will be described. In Example 1-4, for example, as illustrated in PO #0 and PO #1 of FIG. 6, a case is assumed in which POs before the frequency hopping is applied are temporally consecutively arranged. In addition, in Example 1-4, an example is assumed in which when the frequency hopping with a gap is applied, the second hop is shifted backward by the gap. Hereinafter, a case is assumed in which PO #1 and PO #2 are temporally consecutive.

In this case, for example, in a case where the frequency hopping with a gap is applied to the preceding PO #1, a part of the end of the second hop of PO #1 overlaps a starting part of PO #2. In order to prevent such an overlap, in Example 1-4, a starting position of the subsequent PO is shifted backward in accordance with a gap length between the first hop and the second hop of the preceding PO. In the subsequent PO, the frequency hopping may be applied or may not be applied.

In addition, a gap may be configured (or designated) between POs (for example, between PO #1 and PO #2), and in this case, the starting position of the subsequent PO may be shifted in accordance with a value obtained by adding the configured gap and the gap between the first hop and the second hop of the preceding PO. Note that, in a case where the frequency hopping is applied, the gap between POs may not be applied.

FIG. 14 illustrates the arrangement of a case where a starting time position of PO #2 is shifted by the gap between the hops when the frequency hopping is applied to each of the PO #1 and PO #2.

A more specific operation will be described. For example, the starting position with respect to each of PO #1 and PO #2 (for example, the time offset from the corresponding RO), the time length, the frequency position, the frequency offset of the frequency hopping, and the time offset indicating the gap are configured in the user terminal 20, by the configuration information that is transmitted by the RRC message in S101 of FIG. 5. Note that, one or a plurality of such information items may be pre-configured without being configured from the base station apparatus 10. In addition to the above, the gap between PO #1 and PO #2 may be configured.

For example, the user terminal 20 performs the PUSCH transmission of MsgA by PO #2. At this time, the user terminal 20 performs the PUSCH transmission by the first hop of PO #2 with the time position of the “a starting time position of PO #2 that is configured (or designated)+gap between the hops in PO #1”, as the starting time position of the first hop of PO #2, and performs the PUSCH transmission by the second hop of PO #2 with a gap.

### Example 1-5

Next, Example 1-5 will be described. In Example 1-5, for example, as illustrated in FIG. 6, a case is assumed in which POs before the frequency hopping is applied are temporally consecutively arranged. In addition, in Example 1-5, an example is assumed in which when the frequency hopping with a gap is applied, the second hop is shifted backward by the gap.

In Example 1-5, as the configuration (or the designation) for temporally consecutively arranging POs, a configuration in which the ending time position of the preceding PO and the starting time position of the subsequent PO are consecutive may be performed in the user terminal 20.

That is, in a case where the frequency hopping with a gap is applied to the preceding PO, and the ending time position of the second hop is shifted backward by the gap with respect to the ending time position of the initial PO, the ending time position after being shifted and the starting time position of the subsequent PO are consecutive. Note that, in the subsequent PO, the frequency hopping may be applied or may not be applied.

In addition, the gap may be configured (or designated) between POs (for example, between PO #1 and PO #2), and in this case, the starting position of the subsequent PO is shifted by the configured gap.

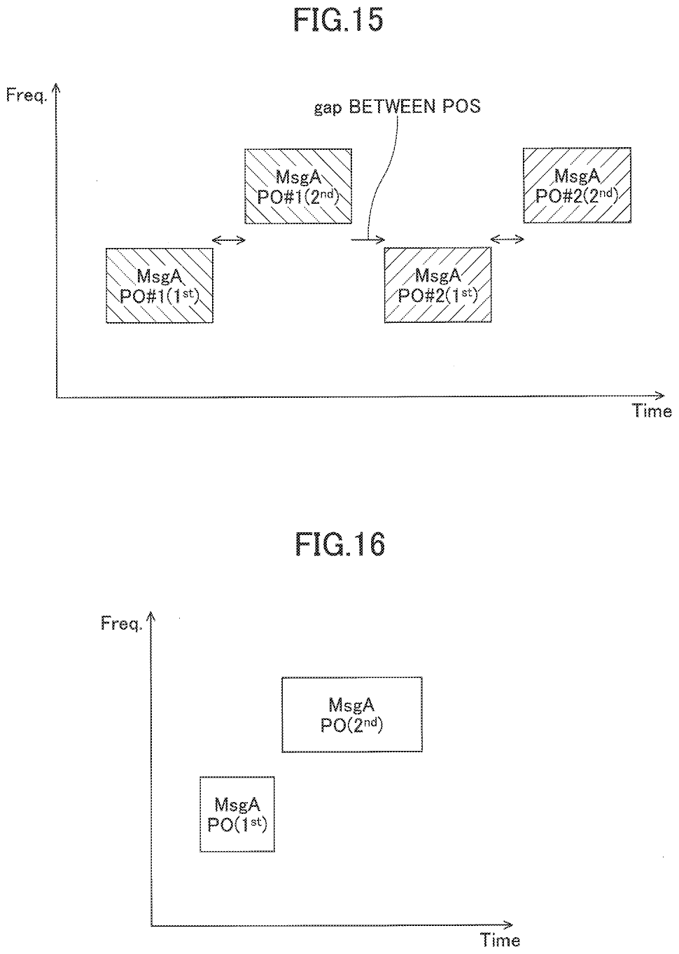

FIG. 15 illustrates the arrangement of a case where the starting time position of PO #2 is shifted from the ending time position of PO #1 by the gap between POs when the frequency hopping is applied to each of PO #1 and PO #2. In a case where the gap between POs is not configured, the first hop of PO #2 is arranged to be temporally consecutive with the second hop of PO #1.

A more specific operation will be described. For example, the “starting position of PO #1 (for example, the time offset from the corresponding RO), the time length, the frequency position, the frequency offset of the frequency hopping, the time offset indicating the gap”, and the “starting position of PO #2 is consecutive with the ending position of PO #1, and the time length of PO #2, the frequency position, the frequency offset of the frequency hopping, and the time offset indicating the gap”, and the “time offset indicating the gap between PO #1 and PO #2” are configured in the user terminal 20 by the configuration information that is transmitted by the RRC message in S101 of FIG. 5.

Note that, any one or a plurality of the above may be designated in advance without being configured from the base station apparatus 10.

For example, the user terminal 20 performs the PUSCH transmission of MsgA by PO #2. At this time, the user terminal 20 performs the PUSCH transmission by the first hop of PO #2 with a time position in which the gap between POs is added to the ending time position of PO #1 (the ending time position of the second hop) after the gap between the hops of PO #1 is applied, as the starting time position of the first hop of PO #2, and performs the PUSCH transmission by the second hop of PO #2 with a gap.

### Example 2

Next, Example 2 will be described. In the examples described above, when the frequency hopping is applied to the PUSCH transmission of MsgA, a time length of the first hop and a time length of the second hop are identical to each other. However, this is an example, and in the examples described above, the time length of the first hop and the time length of the second hop may be different from each other.

An example in which the time length of the first hop and the time length of the second hop are different from each other will be described as Example 2. Note that, in Example 2, the gap between the hops may be configured or may not be configured.

FIG. 16 illustrates an example in which in a certain PO, when the frequency hopping is applied, the time length of the first hop is shorter than the time length of the second hop.

A more specific operation will be described. For example, the starting position with respect to a certain PO (for example, the time offset from the corresponding RO), the frequency position, the frequency offset of the frequency hopping, the time length of the first hop, and the time length of the second hop are configured in the user terminal 20 by the configuration information that is transmitted by the RRC message in S101 of FIG. 5. Note that, one or a plurality thereof may be designated in advance without being configured from the base station apparatus 10, or may be pre-configured in the user terminal 20. In addition to the above, the gap between the hops may be configured.

As a configuration (or a designation) method of the time length of the first hop and the time length of the second hop, the time length of the first hop and the time length of the second hop may be respectively configured or designated, a time length of the entire PO, and a ratio of the time length of the first hop (or the second hop) to the time length of the entire PO may be configured or designated, or the other method may be used.

For example, the user terminal 20 performs the PUSCH transmission of MsgA by PO described above. At this time, the user terminal 20 performs the PUSCH transmission by the time length configured by the first hop of PO with the configured (or designated) starting time position of PO, as the starting time position of the first hop of PO, and performs the PUSCH transmission by the time length configured by the second hop of PO.

### Example 3

Next, Example 3 will be described. Example 3 may be implemented by being combined with Examples 1, 2, and 4, or may be implemented independently from Examples 1, 2, and 4. Here, it is assumed that Example 3 is implemented by being combined with Example 1.

As described above, in the 2-step RACH, it is assumed that the user terminal 20 does not retain the value of TA based on the propagation latency, in a step in which the user terminal 20 transmits MsgA. In this case, in a case where the PUSCH transmission of MsgA is performed using TA=0, the interference as illustrated in FIG. 9 occurs.

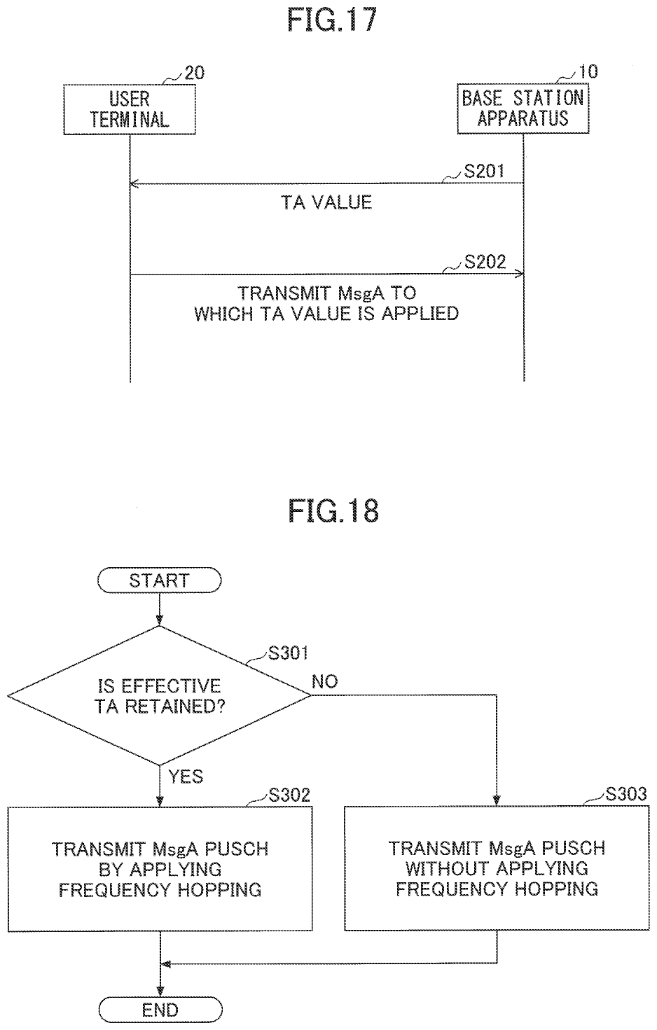

Therefore, in Example 3, as illustrated in S201 of FIG. 17, the TA value used in the PUSCH transmission of MsgA is notified to the user terminal 20 from the base station apparatus 10. The TA value is greater than 0, and for example, is a maximum value (for example, 3846) that can be taken. The TA value may be included in the configuration information of the RRC message in S101 of FIG. 5.

In S202, the user terminal 20 applies the TA value that is received in S201, determines the transmission timing of the PUSCH transmission of MsgA, and performs the PUSCH transmission of MsgA at the transmission timing.

Note that, the example described above is an example of a case where the TA value is notified to the user terminal 20 from the base station apparatus 10. Alternatively, the TA value for the PUSCH transmission of MsgA may be defined and may be pre-configured in the user terminal 20.

In addition, the TA value used in a case where the frequency hopping is applied in the PUSCH transmission of MsgA may be configured (or designated) as the TA value. In this case, the user terminal 20 applies the TA value in a case where the frequency hopping is applied in the PUSCH transmission of MsgA, and performs the PUSCH transmission of the first hop and the second hop.

In addition, the TA value used in a case where the frequency hopping is applied in the PUSCH transmission of MsgA and the TA value used in a case where the frequency hopping is not applied in the PUSCH transmission of MsgA may be configured (or designated) as the TA value.

Note that, in a case where the maximum value (alternatively, a value that is large but is not the maximum value) is used as the TA value when the frequency hopping is applied, the user terminal 20 transmits the first hop and the second hop much earlier than the propagation latency, but the actual starting time position of the first hop can be later than the TA value by adjusting the starting time position of the first hop, and thus, for example, it is possible to suitably avoid the occurrence of a phenomenon as illustrated in FIG. 9. In the second hop, the actual starting time position can be shifted backward by applying the gap.

### Example 4

Next, Example 4 will be described. Example 4 is implemented by being combined with Example 1. However, the combination of Example 4 and Example 1 is an example, and Example 4 may be combined with Examples 2 and 3.

In Example 4, only in a case where the user terminal 20 retains a valid (effective) TA value in the PUSCH transmission of MsgA, the frequency hopping is applied to the PUSCH transmission of MsgA. The user terminal 20 applies the TA value in the transmission of the first hop and the second hop.

A specific operation will be described with reference to a flowchart of FIG. 18. For example, the starting position with respect to a certain PO (for example, the time offset from the corresponding RO), the frequency position, the frequency offset of the frequency hopping, the time offset indicating the gap, the time length of PO, and the like are configured in the user terminal 20 by the configuration information that is transmitted by the RRC message in S101 of FIG. 5. Note that, one or a plurality thereof may be designated in advance and may be pre-configured in the user terminal 20, without being configured from the base station apparatus 10.

For example, the user terminal 20 performs the PUSCH transmission of MsgA by PO described above. At this time, in S301 of FIG. 18, the user terminal 20 determines whether or not the effective TA is retained.

A method for determining whether or not the effective TA is retained is not limited to a specific method. For example, in a case where a time alignment timer (TA timer) is not expired, it may be determined that the effective TA is retained. In addition, in a case where the value of the reception power (RSRP) of the signal from the base station apparatus 10, which is measured by the user terminal 20, is greater than or equal to the threshold value, it may be determined that the effective TA is retained. In addition, in a case where a change amount in the value of the reception power (RSRP) of the signal from the base station apparatus 10, which is measured by the user terminal 20, during a certain period is less than or equal to the threshold value, it may be determined that the effective TA is retained.

In a case where a judgement result of S301 is Yes, the flow proceeds to S302, and the user terminal 20 applies the frequency hopping and performs the PUSCH transmission of MsgA. In a case where the judgement result of S301 is No, the flow proceeds to S303, and the user terminal 20 performs the PUSCH transmission of MsgA without applying the frequency hopping.

As described above, a technology for enabling the frequency hopping of the PUSCH transmission in the random access procedure to be suitably executed is provided by the technology described in Examples 1 to 4.

(Apparatus Configuration)

Next, a function configuration example of the base station apparatus 10 and the user terminal 20 that execute the processing and the operation described above will be described. The base station apparatus 10 and the user terminal 20 have functions for implementing Examples 1 to 4 described above. However, each of the base station apparatus 10 and the user terminal 20 may have only a part of the functions in any one of Examples 1 to 4.

<Base Station Apparatus 10>

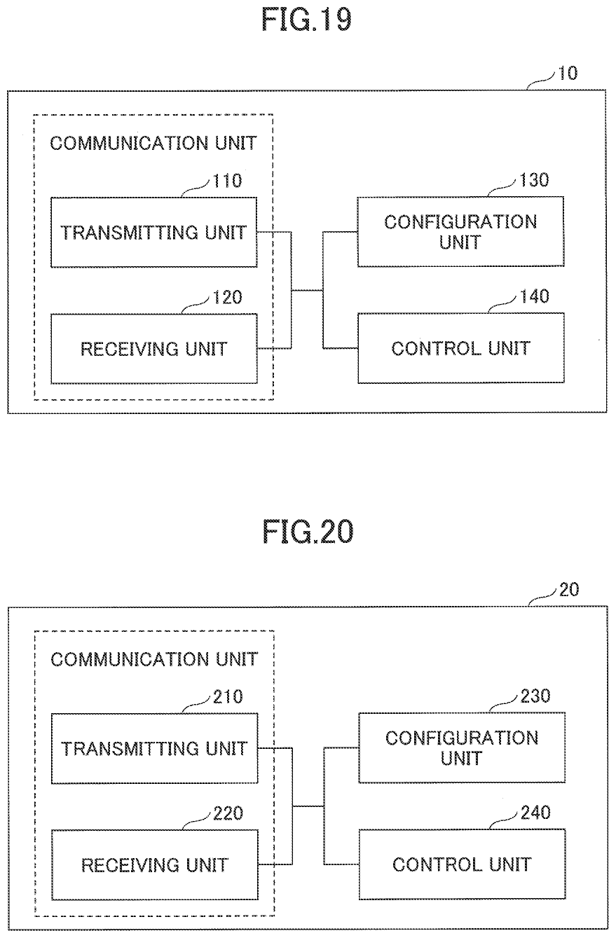

FIG. 19 is a diagram illustrating an example of a function configuration of the base station apparatus 10. As illustrated in FIG. 19, the base station apparatus 10 includes a transmitting unit 110, a receiving unit 120, a configuration unit 130, and a control unit 140. The function configuration illustrated in FIG. 19 is merely an example. Any names may be used for functional segments and functional parts, insofar as the operation according to the embodiment of the invention can be executed. The transmitting unit 110 and the receiving unit 120 may be referred to as a communication unit.

The transmitting unit 110 has a function of generating a signal that is transmitted to the user terminal 20 side and of transmitting the signal over the radio. The receiving unit 120 has a function of receiving various signals that are transmitted from the user terminal 20 and of acquiring, for example, information of a higher layer from the received signals. In addition, the transmitting unit 110 has a function of transmitting NR-PSS, NR-SSS, NR-PBCH, a DL/UL control signal, DL data, or the like to the user terminal 20.

The configuration unit 130 stores the configuration information that is pre-configured, and various configuration information items that are transmitted to the user terminal 20, in a storage unit, and as necessary, reads out the information from the storage unit. The contents of the configuration information, for example, are the preamble resource, the PUSCH resource, a RAR window length, and the like, which are used for the random access procedure. The configuration information (the MsgA PUSCH configuration or the like) described in Examples 1 to 4 is read out from the configuration unit 130, and is notified to the user terminal 20 by the transmitting unit 110.

The control unit 140, for example, performs resource allocation, the control of the entire base station apparatus 10, and the like. Note that, a functional part relevant to the signal transmission in the control unit 140 may be included in the transmitting unit 110, and a functional part relevant to the signal reception in the control unit 140 may be included in the receiving unit 120. In addition, the transmitting unit 110 and the receiving unit 120 may be referred to as a transmitter and a receiver, respectively.

<User Terminal 20>

FIG. 20 is a diagram illustrating an example a function configuration of the user terminal 20. As illustrated in FIG. 20, the user terminal 20 includes a transmitting unit 210, a receiving unit 220, a configuration unit 230, and a control unit 240. The function configuration illustrated in FIG. 20 is merely an example. Any names may be used for functional segments and functional parts, insofar as the operation according to the embodiment of the invention can be executed. The transmitting unit 210 and the receiving unit 220 may be referred to as a communication unit.

The transmitting unit 210 prepares a transmission signal from transmission data and transmits the transmission signal over the radio. The receiving unit 220 receives various signals over the radio and acquires a higher layer signal from the received signal of a physical layer.

The configuration unit 230 stores various configuration information items that are received from the base station apparatus 10 by the receiving unit 220, in a storage unit, and as necessary, reads out the information from the storage unit. In addition, the configuration unit 230 also stores the configuration information that is pre-configured. The contents of the configuration information, for example, are the configuration information described in Examples 1 to 4, and the preamble resource, the PUSCH resource, the RAR window length, and the like, which are used for the random access procedure.

The control unit 240 performs the control and the like described in Examples 1 to 4. For example, the control unit 240 acquires a free time (the gap length) between the first hop and the second hop from the configuration information (time offset corresponding to a gap, time offset from an ending position of a MsgA PO slot, and the like), and the transmitting unit 210 performs transmission with the gap length between the first hop and the second hop. The “acquisition” described above may indicate the acquisition of the configuration information that is stored in the configuration unit 230, or may include necessary calculation in addition to the acquisition of the configuration information.

Note that, a functional part relevant to the signal transmission in the control unit 240 may be included in the transmitting unit 210, and a functional part relevant to the signal reception in the control unit 240 may be included in the receiving unit 220. In addition, the transmitting unit 210 and the receiving unit 220 may be referred to as a transmitter and a receiver, respectively.

The terminal as the user terminal 20, for example, is configured at least as a terminal described in each item described below.

(First Item)

A terminal including:
a control unit acquiring a gap length between a first hop and a second hop in PUSCH transmission to which frequency hopping in a random access procedure is applied; and
a transmitting unit performing the PUSCH transmission by the first hop and then the PUSCH transmission by the second hop after the gap length.

(Second Item)

The terminal according to the first item, further including:
a receiving unit receiving time offset indicating the gap length from a base station apparatus or receiving a relative time position from a reference time position with respect to the second hop from base station apparatus,
in which the control unit acquires the gap length on the basis of the time offset or the relative time position.

(Third Item)

The terminal according to the first item or the second item,
in which the transmitting unit starts subsequent transmission of the first hop consecutively from an ending time position of the second hop of preceding PUSCH transmission, or starts the subsequent transmission of the first hop from the ending time position of the second hop of the preceding PUSCH transmission with a gap.

(Fourth Item)

The terminal according to any one of the first item to the third item,
in which a time length of the first hop and a time length of the second hop are not the same time length.

(Fifth Item)

The terminal according to any one of the first item to the fourth item,
in which the transmitting unit performs the PUSCH transmission by the first hop and the second hop, by applying a TA value that is notified from the base station apparatus or a TA value that is pre-configured in the terminal.

(Sixth Item)

The terminal according to any one of the first item to the fifth item,
in which the control unit judges whether or not the terminal retains an effective TA value, and only in a case where it is judged that the terminal retains the effective TA value, in the random access procedure, the control unit determines to perform the PUSCH transmission to which the frequency hopping is applied.

According to any one of the first item to the sixth item, the technology for enabling the frequency hopping of the PUSCH transmission in the random access procedure to be suitably executed is also provided.

(Hardware Configuration)

The block diagrams (FIG. 19 and FIG. 20) used in the description of the embodiment described above illustrate the block of functional unit. Such function blocks (configuration parts) are attained by at least one arbitrary combination of hardware and software. In addition, an attainment method of each of the function blocks is not particularly limited. That is, each of the function blocks may be attained by using one apparatus that is physically or logically coupled, by directly or indirectly (for example, in a wired manner, over the radio, or the like) connecting two or more apparatuses that are physically or logically separated and by using such a plurality of apparatuses. The function block may be attained by combining one apparatus described above or a plurality of apparatuses described above with software.

The function includes determining, determining, judging, calculating, computing, processing, deriving, investigating, looking up, ascertaining, receiving, transmitting, output, accessing, resolving, selecting, choosing, establishing, comparing, assuming, expecting, presuming, broadcasting, notifying, communicating, forwarding, configuring, reconfiguring, allocating (mapping), assigning, and the like, but is not limited thereto. For example, a function block (a configuration part) that functions transmission is referred to as the transmitting unit or the transmitter. As described above, the attainment method thereof is not particularly limited.

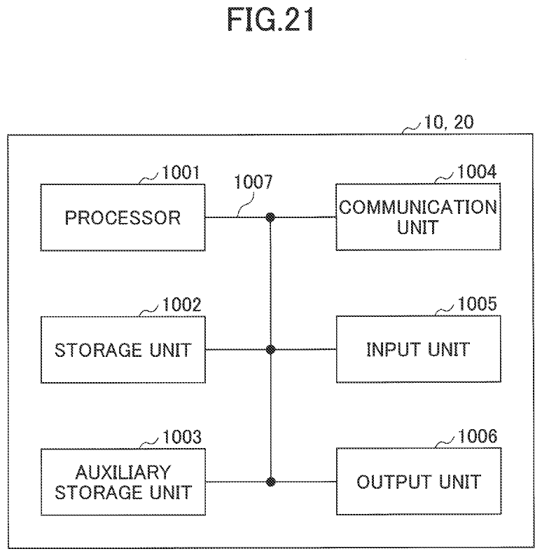

For example, the base station apparatus 10, the user terminal 20, and the like in one embodiment of this disclosure may function as a computer for performing the processing of a radio communication method of this disclosure. FIG. 21 is a diagram illustrating an example of a hardware configuration of the base station apparatus 10 and the user terminal 20 according to one embodiment of this disclosure. The base station apparatus 10 and the user terminal 20 described above may be physically configured as a computer apparatus including a processor 1001, a storage unit 1002, an auxiliary storage unit 1003, a communication unit 1004, an input unit 1005, an output unit 1006, a bus 1007, and the like.

Note that, in the following description, the word “apparatus” can be replaced with a circuit, a device, a unit, or the like. The hardware configuration of the base station apparatus 10 and the user terminal 20 may be configured to include one or a plurality of apparatuses illustrated in the drawings, or may be configured not to include a part of the apparatuses.

Each function of the base station apparatus 10 and the user terminal 20 is attained by reading predetermined software (a program) is read on hardware such as the processor 1001 and the storage unit 1002 such that the processor 1001 performs an operation, and by controlling the communication of the communication unit 1004 or by controlling at least one of reading and writing of data in the storage unit 1002 and the auxiliary storage unit 1003.

The processor 1001, for example, controls the entire computer by operating an operating system. The processor 1001 may be configured by a central processing unit (CPU) including an interface with respect to the peripheral equipment, a control apparatus, an operation apparatus, a register, and the like. For example, the control unit 140, the control unit 240, or the like, described above, may be attained by the processor 1001.

In addition, the processor 1001 reads out a program (a program code), a software module, data, and the like to the storage unit 1002 from at least one of the auxiliary storage unit 1003 and the communication unit 1004, and thus, executes various processings. A program for allowing a computer to execute at least a part of the operation described in the embodiment described above is used as the program. For example, the control unit 140 of the base station apparatus 10 illustrated in FIG. 19 may be attained by a control program that is stored in the storage unit 1002 and is operated by the processor 1001. In addition, for example, the control unit 240 of the user terminal 20 illustrated in FIG. 20 may be attained by a control program that is stored in the storage unit 1002 and is operated by the processor 1001. It has been described that the various processings described above are executed by one processor 1001, but the processings may be simultaneously or sequentially executed by two or more processors 1001. The processor 1001 may be mounted on one or more chips. Note that, the program may be transmitted from a network through an electric communication line.

The storage unit 1002 is a computer readable recording medium, and for example, may be configured of at least one of a read only memory (ROM), an erasable programmable ROM (EPROM), an electrically erasable programmable ROM (EEPROM), a random access memory (RAM), and the like. The storage unit 1002 may be referred to as a register, a cache, a main memory (a main storage unit), and the like. The storage unit 1002 is capable of retaining a program (a program code) that can be executed in order to implement a communication method according to one embodiment of this disclosure, a software module, and the like.

The auxiliary storage unit 1003 is a computer readable recording medium, and for example, may be configured of at least one of an optical disk such as a compact disc ROM (CD-ROM), a hard disk drive, a flexible disk, a magnetooptical disk (for example, a compact disc, a digital versatile disk, and a Blu-ray (Registered Trademark) disk), a smart card, a flash memory (for example, a card, a stick, a key drive), a floppy (Registered Trademark) disk, a magnetic strip, and the like. The auxiliary storage unit 1003 may be referred to as an auxiliary storage unit. The storage medium described above, for example, may be a database including at least one of the storage unit 1002 and the auxiliary storage unit 1003, a server, and a suitable medium.

The communication unit 1004 is hardware for performing communication with respect to the computer through at least one of a wire network and a radio network (a transmitting and receiving device), and for example, is also referred to as a network device, a network controller, a network card, a communication module, and the like. The communication unit 1004, for example, may be configured by including a high frequency switch, a duplexer, a filter, a frequency synthesizer, and the like, in order to attain at least one of frequency division duplex (FDD) and time division duplex (TDD). For example, a transmitting and receiving antenna, an amplifier, a transmitting and receiving unit, a transmission path interface, and the like may be attained by the communication unit 1004. In the transmitting and receiving unit, the transmitting unit and the receiving unit are mounted by being physically or logically separated.

The input unit 1005 is an input device for receiving input from the outside (for example, a keyboard, a mouse, a microphone, a switch, a button, a sensor, and the like). The output unit 1006 is an output device for implementing output with respect to the outside (for example, a display, a speaker, an LED lamp, and the like). Note that, the input unit 1005 and the output unit 1006 may be integrally configured (for example, a touch panel).

In addition, each of the apparatuses such as the processor 1001 and the storage unit 1002 may be connected by the bus 1007 for performing communication with respect to information. The bus 1007 may be configured by using a single bus, or may be configured by using buses different for each of the apparatuses.

In addition, the base station apparatus 10 and the user terminal 20 may be configured by including hardware such as a microprocessor, a digital signal processor (DSP), an application specific integrated circuit (ASIC), a programmable logic device (PLD), and a field programmable gate array (FPGA), and a part or all of the respective function blocks may be attained by the hardware. For example, the processor 1001 may be mounted by using at least one of the hardwares.

(Supplement to Embodiment)

As described above, the embodiment of the invention has been described, but the disclosed invention is not limited to the embodiment, and a person skilled in the art will understand various modification examples, correction examples, alternative examples, substitution examples, and the like. Specific numerical examples have been described in order to facilitate the understanding of the invention, but the numerical values are merely an example, and any appropriate values may be used, unless otherwise specified. The classification of the items in the above description is not essential to the invention, and the listings described in two or more items may be used by being combined, as necessary, or the listing described in one item may be applied to the listing described in another item (insofar as there is no contradiction). A boundary between the functional parts or the processing parts in the function block diagram does not necessarily correspond to a boundary between physical components. The operations of a plurality of functional parts may be physically performed by one component, or the operation of one functional part may be physically performed by a plurality of components. In a processing procedure described in the embodiment, a processing order may be changed, insofar as there is no contradiction. For the convenience of describing the processing, the base station apparatus 10 and the user terminal 20 have been described by using a functional block diagram, but such an apparatus may be attained by hardware, software, or a combination thereof. Each of software that is operated by a processor of the base station apparatus 10 according to the embodiment of the invention and software that is operated by a processor of the user terminal 20 according to the embodiment of the invention may be retained in a random access memory (RAM), a flash memory, a read only memory (ROM), an EPROM, an EEPROM, a register, a hard disk (HDD), a removable disk, a CD-ROM, a database, a server, and other suitable recording media.

In addition, the notification of the information is not limited to the aspect/embodiment described in this disclosure, and may be performed by using other methods. For example, the notification of the information may be implemented by physical layer signaling (for example, downlink control information (DCI) and uplink control information (UCI)), higher layer signaling (for example, radio resource control (RRC) signaling, medium access control (MAC) signaling, broadcast information (a master information block (MIB)), a system information block (SIB)), other signals, or a combination thereof. In addition, the RRC signaling may be referred to as an RRC message, and for example, may be an RRC connection setup message, an RRC connection reconfiguration message, and the like.

Each aspect/embodiments described in this disclosure may be applied to a system using long term evolution (LTE), LTE-advanced (LTE-A), SUPER 3G, IMT-advanced, a 4th generation mobile communication system (4G), a 5th generation mobile communication system (5G), future radio access (FRA), new radio (NR), W-CDMA (Registered Trademark), GSM (Registered Trademark), CDMA2000, an ultra mobile broadband (UMB), IEEE 802.11 (Wi-Fi (Registered Trademark)), IEEE 802.16 (WiMAX (Registered Trademark)), IEEE 802.20, an ultra-wideband (UWB), Bluetooth (Registered Trademark), and other suitable systems and a next-generation system that is expanded on the basis thereof. In addition, a combination of a plurality of systems (for example, a combination of at least one of LTE and LTE-A and 5G, and the like) may be applied.

In the processing procedure, the sequence, the flowchart, and the like of each aspect/embodiment described herein, the order may be changed, insofar as there is no contradiction. For example, in the method described in this disclosure, the elements of various steps are presented by using an exemplary order, but are not limited to the presented specific order.

Here, a specific operation that is performed by the base station apparatus 10 may be performed by an upper node, in accordance with a case. In a network provided with one or a plurality of network nodes including the base station apparatus 10, it is obvious that various operations that are performed in order for communication with respect to the user terminal 20 can be performed by at least one of the base station apparatus 10 and network nodes other than the base station apparatus 10 (for example, MME, S-GW, or the like is considered as the network node, but the network node is not limited thereto). In the above description, a case is exemplified in which the number of network nodes other than the base station apparatus 10 is 1, but a plurality of other network nodes may be combined (for example, the MME and the S-GW).

The information, the signal, or the like described in this disclosure can be output to a lower layer (or the higher layer) from the higher layer (or the lower layer). The information, the signal, or the like may be input and output through a plurality of network nodes.

The information or the like that is input and output may be retained in a specific location (for example, a memory), or may be managed by using a management table. The information or the like that is input and output can be subjected to overwriting, updating, or editing. The information or the like that is output may be deleted. The information or the like that is input may be transmitted to the other apparatuses.

Judgment in this disclosure may be performed by a value represented by 1 bit (0 or 1), may be performed by a truth-value (Boolean: true or false), or may be performed by a numerical comparison (for example, a comparison with a predetermined value).

Regardless of whether the software is referred to as software, firmware, middleware, a microcode, and a hardware description language, or is referred to as other names, the software should be broadly interpreted to indicate a command, a command set, a code, a code segment, a program code, a program, a sub-program, a software module, an application, a software application, a software package, a routine, a sub-routine, an object, an executable file, an execution thread, a procedure, a function, and the like.

In addition, software, a command, information, and the like may be transmitted and received through a transmission medium. For example, in a case where the software is transmitted from a website, a server, or other remote sources by using at least one of a wire technology (a coaxial cable, an optical fiber cable, a twisted pair, a digital subscriber line (DSL), and the like) and a radio technology (an infrared ray, a microwave, and the like), at least one of the wire technology and the radio technology is included in the definition of the transmission medium.

The information, the signal, and the like described in this disclosure may be represented by using any of various different technologies. For example, the data, the command, the command, the information, the signal, the bit, the symbol, the chip, and the like that can be referred to through the entire description described above may be represented by a voltage, a current, an electromagnetic wave, a magnetic field or magnetic particles, an optical field or a photon, or an arbitrary combination thereof.

Note that, the terms described in this disclosure and the terms necessary for understanding this disclosure may be replaced with terms having the same or similar meaning. For example, at least one of the channel and the symbol may be a signal (signaling). In addition, the signal may be a message. In addition, a component carrier (CC) may be referred to as a carrier frequency, a cell, a frequency carrier, and the like.

The terms “system” and “network” used in this disclosure are interchangeably used.

In addition, the information, the parameter, and the like described in this disclosure may be represented by using an absolute value, may be represented by using a relative value from a predetermined value, or may be represented by using another corresponding information. For example, a radio resource may be indicated by an index.

The names used in the parameters described above are not a limited name in any respect. Further, expressions or the like using such parameters may be different from those explicitly disclosed in this disclosure. Various channels (for example, PUSCH, PUCCH, PDCCH, and the like) and information elements can be identified by any suitable name, and thus, various names that are allocated to such various channels and information elements are not a limited name in any respect.

In this disclosure, the terms “base station (BS)”, “radio base station”, “base station apparatus”, “fixed station”, “NodeB”, “eNodeB (eNB)”, “gNodeB (gNB)”, “access point”, “transmission point”, “reception point”, “transmission and reception point”, “cell”, “sector”, “cell group”, “carrier”, “component carrier”, and the like can be interchangeably used. The base station may be referred to by a term such as a macrocell, a small cell, a femtocell, and a picocell.

The base station is capable of accommodating one or a plurality of (for example, three) cells. In a case where the base station accommodates a plurality of cells, the entire coverage area of the base station can be classified into a plurality of small areas, and each of the small areas is capable of providing communication service by a base station sub-system (for example, an indoor type small base station (a remote radio head (RRH)). The term “cell” or “sector” indicates a part of the coverage area or the entire coverage area of at least one of the base station and the base station sub-system that perform the communication service in the coverage.

In this disclosure, the terms “mobile station (MS)”, “user terminal”, “user equipment (UE)”, and “terminal” can be interchangeably used.

The mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a terminal, a wireless terminal, a remote terminal, a handset, a user agent, a mobile client, a client, or other suitable terms, by a person skilled in the art.

At least one of the base station and the mobile station may be referred to as a transmitting apparatus, a receiving apparatus, a communication unit, and the like. Note that, at least one of the base station and the mobile station may be a device that is mounted on a mobile object, the mobile object itself, or the like. The mobile object may be a vehicle (for example, a car, an airplane, and the like), may be a mobile object that is moved in an unmanned state (for example, a drone, an autonomous driving car, and the like), or may be a (manned or unmanned) robot. Note that, at least one of the base station and the mobile station also includes an apparatus that is not necessarily moved at the time of a communication operation. For example, at least one of the base station and the mobile station may be an internet of things (IoT) device such as a sensor.

In addition, the base station apparatus in this disclosure may be replaced with the user terminal. For example, each aspect/embodiment of this disclosure may be applied to a configuration in which communication between the base station apparatus and the user terminal is replaced with communication in a plurality of user terminals 20 (for example, may be referred to as device-to-device (D2D), vehicle-to-everything (V2X), and the like). In this case, the function of the base station apparatus 10 described above may be provided in the user terminal 20. In addition, the words “up”, “down”, and the like may be replaced with words corresponding to the communication between the terminals (for example, “side”). For example, an up channel, a down channel, and the like may be replaced with a side channel.

Similarly, the user terminal in this disclosure may be replaced with the base station apparatus. In this case, the function of the user terminal described above may be provided in the base station apparatus.

The terms “determining” and “determining” used in this disclosure may involve diverse operations. “Determining” and “determining”, for example, are capable of including “determining” and “determining” with respect to judging, calculating, computing, processing, deriving, investigating, looking up (search, inquiry) (for example, looking up in a table, a database, or another data structure), and ascertaining, and the like. In addition, “determining” and “determining” are capable of including “determining” and “determining” with respect to receiving (for example, receiving information), transmitting (for example, transmitting information), input, output, and accessing (for example, accessing data in a memory), and the like. In addition, “determining” and “determining” are capable of including “determining” and “determining” with respect to resolving, selecting, choosing, establishing, comparing, and the like. That is, “determining” and “determining” are capable of including “determining” and “determining” with respect to any operation. In addition, “determining (determining)” may be replaced with “assuming”, “expecting”, “considering”, and the like.

The terms “connected” and “coupled”, or any modification thereof indicate any direct or indirect connection or couple in two or more elements, and are capable of including a case where there are one or more intermediate elements between two elements that are “connected” or “coupled” to each other. The couple or connection between the elements may be physical couple or connection, may be logical couple or connection, or may be a combination thereof. For example, the “connection” may be replaced with “access”. In the case of being used in this disclosure, it is possible to consider that two elements are “connected” or “coupled” to each other by using at least one of one or more electric wires, cables, and print electric connection, and as some non-limiting and non-inclusive examples, by using electromagnetic energy having a wavelength of a radio frequency domain, a microwave domain, and an optical (visible and invisible) domain, and the like.

The reference signal can also be abbreviated as RS, and may be referred to as pilot on the basis of a standard to be applied.

The description “on the basis of” that is used in this disclosure does not indicate “only on the basis of”, unless otherwise specified. In other words, the description “on the basis of” indicates both “only on the basis of” and “at least on the basis of”.

Any reference to elements using the designations “first,” “second,” and the like, used in this disclosure, does not generally limit the amount or the order of such elements. Such designations can be used in this disclosure as a convenient method for discriminating two or more elements. Therefore, a reference to a first element and a second element does not indicate that only two elements can be adopted or the first element necessarily precedes the second element in any manner.

“Means” in the configuration of each of the apparatuses described above may be replaced with “unit”, “circuit”, “device”, and the like.

In this disclosure, in a case where “include”, “including”, and the modification thereof are used, such terms are intended to be inclusive, as with the term “comprising”. Further, the term “or” that is used in this disclosure is not intended to be exclusive-OR.

A radio frame may be configured of one or a plurality of frames in a time domain. Each of one or a plurality of frames in the time domain may be referred to as a subframe. The subframe may be further configured of one or a plurality of slots in the time domain. The subframe may be a fixed time length (for example, 1 ms) that does not depend on numerology.

The numerology may be a communication parameter to be applied to at least one of the transmission and the reception of a certain signal or channel. The numerology, for example, may indicate at least one of subcarrier spacing (SCS), a bandwidth, a symbol length, a cyclic prefix length, a transmission time interval (TTI), the number of symbols per TTI, a radio frame configuration, specific filtering processing that is performed by the transceiver in a frequency domain, specific windowing processing that is performed by the transceiver in a time domain, and the like.

The slot may be configured of one or a plurality of symbols (an orthogonal frequency division multiplexing (OFDM) symbol, a single carrier frequency division multiple access (SC-FDMA) symbol, and the like) in a time domain. The slot may be time unit based on the numerology.

The slot may include a plurality of mini slots. Each of the mini slots may be configured of one or a plurality of symbols in the time domain. In addition, the mini slot may be referred to as a subslot. The mini slot may be configured of symbols of which the number is less than that of the slot. PDSCH (or PUSCH) to be transmitted in time unit greater than the mini slot may be referred to as a PDSCH (or PUSCH) mapping type A. PDSCH (or PUSCH) to be transmitted by using the mini slot may be referred to as a PDSCH (or PUSCH) mapping type B.

All of the radio frame, the subframe, the slot, the mini slot, and the symbol represent time unit at the time of transmitting a signal. Other designations respectively corresponding to the radio frame, the subframe, the slot, the mini slot, and the symbol may be used.

For example, one subframe may be referred to as a transmission time interval (TTI), a plurality of consecutive subframes may be referred to as TTI, or one slot or one mini slot may be referred to as TTI. That is, at least one of the subframe and TTI may be a subframe (1 ms) in the existing LTE, may be a period shorter than 1 ms (for example, 1 to 13 symbols), or may be a period longer than 1 ms. Note that, unit representing TTI may be referred to as a slot, a mini slot, and the like, but not a subframe.

Here, TTI, for example, indicates minimum time unit of scheduling in radio communication. For example, in an LTE system, the base station performs scheduling for allocating a radio resource (a frequency bandwidth, transmission power, and the like that can be used in each of the user terminals 20) in TTI unit, with respect to each of the terminals 20. Note that, the definition of TTI is not limited thereto.

TTI may be transmission time unit of a data packet (a transport block), a code block, a codeword, and the like that are subjected to channel coding, or may be processing unit of scheduling, link adaptation, and the like. Note that, when TTI is applied, a time zone in which the transport block, the code block, the codeword, and the like are actually mapped (for example, the number of symbols) may be shorter than TTI.

Note that, in a case where one slot or one mini slot is referred to as TTI, one or more TTIs (that is, one or more slots or one or more mini slots) may be the minimum time unit of the scheduling. In addition, the number of slots (the number of mini slots) configuring the minimum time unit of the scheduling may be controlled.

TTI having a time length of 1 ms may be referred to as a common TTI (TTI in LTE Rel. 8-12), a normal TTI, a long TTI, a common subframe, a normal subframe, a long subframe, a slot, and the like. TTI shorter than the common TTI may be referred to as a shortened TTI, a short TTI, a partial TTI (or a fractional TTI), a shortened subframe, a short subframe, a mini slot, a subslot, a slot, and the like.

Note that, the long TTI (for example, the common TTI, the subframe, and the like) may be replaced with TTI having a time length of greater than or equal to 1 ms, and the short TTI (for example, the shortened TTI and the like) may be replaced with TTI having a TTI length of less than a TTI length of the long TTI and greater than or equal to 1 ms.

The resource block (RB) is resource allocation unit of the time domain and the frequency domain, and may include one or a plurality of consecutive subcarriers in the frequency domain. The number of subcarriers included in RB may be the same regardless of the numerology, or for example, may be 12. The number of subcarriers included in RB may be determined on the basis of the numerology.

In addition, the time domain of RB may include one or a plurality of symbols, or may be the length of one slot, one mini slot, one subframe, or one TTI. One TTI, one subframe, and the like may be respectively configured of one or a plurality of resource blocks.

Note that, one or a plurality of RBs may be referred to as a physical resource block (physical RB: PRB), a sub-carrier group (SCG), a resource element group (REG), a PRB pair, a RB pair, and the like.

In addition, the resource block may be configured of one or a plurality of resource elements (RE). For example, one RE may be a radio resource domain of one subcarrier and one symbol.

A bandwidth part (BWP) (may be referred to as a part bandwidth or the like) may represent a subset of consecutive common resource blocks (common RBs) for certain numerology, in a certain carrier. Here, the common RB may be specified by an index of RB based on a common reference point of the carrier. PRB may be defined by a certain BWP, and may be numbered within BWP.

BWP may include BWP for UL (UL BWP) and BWP for DL (DL BWP). In UE, one or a plurality of BWPs may be configured within one carrier.

At least one of the configured BWPs may be active, and it may not assumed that the UE transmits and receives a predetermined signal/channel out of the active BWP. Note that, the “cell”, the “carrier”, and the like in this disclosure may be replaced with “BWP”.

The structure of the radio frame, the subframe, the slot, the mini slot, the symbol, and the like, described above, is merely an example. For example, the configuration of the number of subframes included in the radio frame, the number of slots per a subframe or a radio frame, the number of mini slots included in the slot, the number of symbols and RBs included in the slot or a mini slot, the number of subcarriers included in RB, the number of symbols in TTI, a symbol length, a cyclic prefix (CP) length, and the like can be variously changed.

In this disclosure, for example, in a case where articles such as a, an, and the are added by translation, this disclosure may include a case where nouns following the articles are in the plural.

In this disclosure, the term “A and B are different” may indicate “A and B are different from each other”. Note that, the term may indicate “A and B are respectively different from C”. The terms “separated”, “coupled”, and the like may be interpreted as with “being different”.

Each aspect/embodiment described in this disclosure may be independently used, may be used by being combined, or may be used by being switched in accordance with execution. In addition, the notification of predetermined information (for example, the notification of “being X”) is not limited to being performed explicitly, and may be performed implicitly (for example, the notification of the predetermined information is not performed).

Note that, in this disclosure, an SS block or CSI-RS is an example of the synchronization signal or the reference signal.

As described above, this disclosure has been described in detail, but it is obvious for a person skilled in the art that this disclosure is not limited to the embodiment described in this disclosure. This disclosure can be implemented as corrected and changed modes without departing from the spirit and scope of this disclosure defined by the description of the claims. Therefore, the description in this disclosure is for illustrative purposes and does not have any limiting meaning with respect to this disclosure.

### EXPLANATIONS OF LETTERS OR NUMERALS

10 BASE STATION APPARATUS
110 TRANSMITTING UNIT
120 RECEIVING UNIT
130 CONFIGURATION UNIT
140 CONTROL UNIT
20 USER TERMINAL
210 TRANSMITTING UNIT
220 RECEIVING UNIT
230 CONFIGURATION UNIT
240 CONTROL UNIT
1001 PROCESSOR
1002 STORAGE UNIT
1003 AUXILIARY STORAGE UNIT
1004 COMMUNICATION UNIT
1005 INPUT UNIT
1006 OUTPUT UNIT

1. A terminal comprising:
a control unit configured to acquire a gap length between a first hop and a second hop in PUSCH transmission to which frequency hopping in a random access procedure is applied; and
a transmitting unit configured to perform the PUSCH transmission by the first hop and then the PUSCH transmission by the second hop after the gap length.

2. The terminal according to claim 1, further comprising:
a receiving unit configured to receive time offset indicating the gap length from a base station apparatus or receive a relative time position from a reference time position with respect to the second hop from the base station apparatus,
wherein the control unit acquires the gap length on the basis of the time offset or the relative time position.

3. The terminal according to claim 1 or 2,
wherein the transmitting unit starts subsequent transmission of the first hop consecutively from an ending time position of the second hop of preceding PUSCH transmission, or starts the subsequent transmission of the first hop from the ending time position of the second hop of the preceding PUSCH transmission with a gap.

4. The terminal according to any one of claims 1 to 3,
wherein a time length of the first hop and a time length of the second hop are not the same time length.

5. The terminal according to any one of claims 1 to 4,
wherein the transmitting unit performs the PUSCH transmission by the first hop and the second hop, by applying a TA value that is notified from the base station apparatus or a TA value that is pre-configured in the terminal.

6. The terminal according to any one of claims 1 to 5,
wherein the control unit judges whether or not the terminal retains an effective TA value, and only in a case where it is judged that the terminal retains the effective TA value, in the random access procedure, the control unit determines to perform the PUSCH transmission to which the frequency hopping is applied.
